(19) United States
(12) Patent Application Publication
(10) Pub. No.: US 2013/0051715 A1
(43) Pub. Date: Feb. 28, 2013

(54) ANTI-FRETTING LAYER

(71) Applicant: Jakob Zidar, Altmuenster (AT)

(72) Inventor: Jakob Zidar, Altmuenster (AT)

(73) Assignee: Miba Gleitlager GmbH, Laakirchen (AT)

(21) Appl. No.: 13/640,890

(22) PCT Filed: Apr. 14, 2011
(86) PCT No.: PCT/AT2011/000183

§ 371 Date: Nov. 5, 2012

(30) Foreign Application Priority Data
Apr. 15, 2010 (AT) A 601/2010

(51) Int. Cl. F16C 33/12; C22C 9/00; C25D 7/10; C25D 3/58; B32B 15/04; C25D 3/56

(52) U.S. Cl. 384/276; 428/544; 205/239; 205/240; 205/241; 205/242; 420/473

(57) ABSTRACT

The invention relates to an anti-fretting layer (5) for a multi-layer plain bearing (1), the anti-fretting layer being composed of a copper-based alloy, which in addition to copper as the main alloying element contains at least one element from the group comprising germanium, tin, indium, zinc, nickel, cobalt, bismuth, lead, silver and antimony and unavoidable impurities originating from production, wherein the total fraction of said alloying elements is at least 1 wt. % and at most 30 wt. %, and wherein copper mixed-crystal grains comprising copper and the at least one element are present in the copper alloy, wherein the copper mixed-crystal grains are oriented in such a way that an orientation index M{hkl} according to formula (I)

$$M \{ hkl \} = \frac{I \{ hkl \} \sum {I}^{0} \{ hkl \}}{{I}^{0} \{ hkl \} \sum I \{ hkl \}}$$

of each of the lattice plane sets {hkl} has a value of less than 3.0, wherein I{hkl} represents the X-ray diffraction intensities for the {hkl} lattice planes of the anti-fretting layer and I0 {hkl} represents the X-ray diffraction intensities of the completely unoriented copper powder sample.

The invention relates to an anti-fretting layer for a multi-layered plain bearing consisting of a copper alloy which in addition to copper as the main alloy element contains at least one element from the group germanium, tin, indium, zinc, nickel, cobalt, bismuth, lead, silver, antimony as well as unavoidable impurities originating from production, wherein the sum of these alloy elements is at least 1 wt. % and a maximum of 30 wt. %, and wherein there are copper mixed crystal grains formed in the copper alloy of copper and the at least one element, and also to a multi-layered plain bearing with a front side facing towards an element to be mounted and a rear side opposite the latter, comprising a support layer, an antifrictional layer arranged on the front side and an anti-fretting layer arranged on the rear side, as well as a method for the galvanic deposition of said anti-fretting layer on the back of a support layer of a multilayered plain bearing, wherein the anti-fretting layer is made from a copper alloy, which in addition to copper as the main alloy element contains at least one element from the group germanium, tin, indium, zinc, nickel, cobalt, bismuth, lead, silver, antimony as well as unavoidable impurities originating from production, wherein the sum of these alloy elements is at least 1 wt. % and a maximum of 30 wt. % and can be used in the form of salts in the electrolyte, wherein the deposition of the anti-fretting layer is performed at a temperature of below 85° C. and at a maximum current density of 6 A/dm².

The rear coating of a plain bearing with an anti-fretting layer is already known from the prior art. By means of this coating the frictional welding or frictional corrosion and thereby the “seizing” of the plain bearing is avoided in the bearing housing as a result of unwanted relative movements of the components. Frictional corrosion often leads to frictional fatigue fractures. The frictional corrosion is also determined by the pairing of materials. Hard materials or components with hard surfaces layers are more prone to wear by frictional corrosion than soft materials which are more prone to seizing. In the latter case the relative movement is then prevented and damage is also caused.

In order to address this problem many different materials have already been described in the prior art for the production of an anti-fretting layer. Thus for example AT 506 641 A1 of the same applicant describes a silver alloy for this use. From AT 399 544 B, also of the same Applicant, a corrosion support layer made from an Sn-alloy is known. Ni, Cr or Co alloys for anti-fretting layers are known from GB 2315301 A1. According to WO 02/48563 A1 a tin bronze is used as the anti-fretting layer. A Cu—Sn-alloy deposited galvanically as an anti-fretting layer on steel with a proportion of tin of between 10% and 15% is known from GB 556,248 A and GB 554,355 A.

The problem addressed by the invention is to provide an improved multi-layered plain bearing, in particular an improved anti-fretting layer based on copper.

Said problem is solved independently by means of the aforementioned anti-fretting layer, in which the copper mixed crystal grains are oriented in a way such that an orientation index M{hkl} according to the formula

$$M \{ hkl \} = \frac{I \{ hkl \} \sum {I}^{0} \{ hkl \}}{{I}^{0} \{ hkl \} \sum I \{ hkl \}}$$

of each of the lattice plane sets {hkl} has a value of less than 3.0, wherein I{hkl} represents the X-ray diffraction intensities for the {hkl} lattice planes of the anti-fretting layer and I0{hkl} represents the X-ray intensities of the completely unoriented copper-powder sample (ICDD PDF 00-004-0836), furthermore by the multi-layered plain bearing comprising the anti-fretting layer, and by the aforementioned method in which the electrolyte contains in addition to the salts for the metals to be deposited also contains organic compounds selected from a group comprising polycarboxylic acid salts, naphthol, naphthol derivatives and thio compounds.

To calculate the orientation index on the basis of their relatively high intensity only the reflexes {111}, {200}, {220} and {311} are used. The measurement of the X-ray diffraction intensity is performed in the Bragg-Brentano diffractometer arrangement with Cu-Ka-radiation, wherein lattice planes diffract which are parallel to the surface. By the formation of substitution mixed crystals and the corresponding change in the lattice parameters the positions of the diffraction reflexes, according to the Vengard rule, can be moved 0° to 5°, mostly 0.2° to 2°. Furthermore, the sum of the diffraction intensities ΣI{hkl} or ΣI0{hkl} has to be over the same range.

The calculation of the orientation index is performed advantageously by the {111}, {200}, {220} and {311} reflexes i.e. over a 2theta range of about 43-90°, as the latter can be determined more intensively and therefore more precisely compared to the following {222}, {331} and {420}. For comparison reasons therefore the evaluation of the X-ray diffraction intensities has to be performed for the same reflexes which were obtained under the same conditions.

In the search for an anti-fretting layer with improved properties the Applicant has examined, in addition to the already mentioned silver alloy layers, copper-based alloys containing at least one additional alloy element, such as e.g. tin, and has established surprisingly that many of these copper-based alloys have much better wearing properties and/or a much greater fatigue strength, and in each case improved protection from damage through fretting than others.

By investigating the structure of said copper-based alloys by means of X-ray diffractometry it could be established from the diffraction patterns that the copper mixed crystal grains in said copper-based alloys had a much clearer orientation of symmetry-determined equivalent planes in one direction. It is suspected that the improved properties are determined by the oriented copper mixed crystal grains, as copper-based alloys with the same compositions but different orientations of the copper mixed crystal grains had worse properties.

Preferably, the value of the orientation index M{hkl} of each lattice plane set according to the Miller index is less than 2.75, in particular less than 2.5.

This effect of improved wearing properties was achieved in particular when at least one of the following conditions was met:
the orientation index of the {220} reflex is below the value 1.0 and/or
the X-ray diffraction intensity of the {200} lattice planes is between 50% and 200% of the X-ray diffraction intensity of the {111} lattice planes and/or
the sum of the X-ray diffraction intensity of I{111} and I{200} is at least 70%, preferably at least 80%, of the total X-ray diffraction intensity and/or
the X-ray diffraction intensity I{111} is at least 70%, preferably at least 85%, of the total X-ray diffraction intensity.

According to one embodiment variant of the anti-fretting layer the tin content is between 5 wt. % and 25 wt. %, preferably between 8 wt. % and 19 wt. %, in particular between 10 wt. % and 16 wt. %. In this way the hardness of the anti-fretting is increased, whereby on the one hand the tendency towards “seizing” is reduced and on the other hand also the wearing resistance is also increased further. Above 25 wt. % predominantly intermetallic phases are formed which are very brittle, whereby the wearing resistance reduces further. Below 5 wt. % however slight improvements are observed which have not in themselves resulted in the desired improvements.

The zinc content can be between 0.5 wt. % and 25 wt. %, preferably between 1 wt. % and 5 wt. %. In this way the permanent durability and the elasticity of anti-fretting layer is improved. In addition, the corrosion resistance of the copper alloy is improved. Above 25 wt. % the protection from fretting is reduced. Below 0.5 wt. % no essential improvement in the properties of the copper alloy could be observed.

It is also possible for the anti-fretting layer to contain one or more of the elements germanium, indium, zinc, nickel, cobalt, bismuth, lead and antimony, wherein the total amount thereof is between 0.2 wt. % and 20 wt. %. It is thereby possible to adapt the anti-fretting layer further for highly stressed bearings.

The corrosion resistance of the anti-fretting layer is improved by nickel and cobalt.

To improve the anti-frictional property of the anti-fretting layer in addition to the copper mixed crystal phase a slidable soft phase can be provided in the matrix, which is formed in particular by lead, bismuth, silver or at least one solid lubricant such as MoS₂, graphite, WS₂ etc.

Germanium, indium and antimony improve the adaptability and/or the corrosion resistance of the anti-fretting layer to the housing mounting the plain bearing.

According to an embodiment variant of the anti-fretting layer the latter has a layer thickness of between 2 μm and 100 μm, preferably between 3 μm and 30 μm, in particular between 4 μm and 15 μm. By keeping the lower limit of 2 μm for the layer thickness the anti-fretting layer forms a cohesive layer even after the wear to the roughness peaks. At layer thicknesses of over 100 μm a worse adhesion of the anti-fretting layer on the base was observed by tensions on the interface.

The anti-fretting layer preferably has a Vickers micro-hardness for a test load of 3 Pond of between HV 200 and HV 500, preferably between HV 230 and HV 400 in particular between HV 250 and HV 350, whereby the abrasion caused by micromovements of the plain bearing can be reduced in the housing and thus the frictional corrosion of the anti-fretting layer can be reduced further. Above 500 HV the plastic deformability is mostly so low that forces acting locally lead to the formation of tears and breaks in the layer. Below 200 HV the wearing resistance is not achieved to the desired extent.

Preferably, the copper mixed crystal grains in the anti-fretting layer have a grain size of more than 5 nm, preferably more than 10 nm, in particular more than 50 nm. In this way the crystalline nature of the copper-based alloy is more marked and as a result also the properties dependent on the orientation described above are more prevalent.

According to one embodiment variant the anti-fretting layer is preferably essentially free of intermetallic phases and appears in the XRD measurement as mixed crystals with copper crystal lattices, whereby according to a preferred embodiment variant the latter is made of copper mixed crystals with a lattice constant of between 0.3630 nm and 0.3750 nm. In this way the formation of the preferred alignment of the copper mixed crystal grains in the layer of copper-based alloy is supported and at least not impaired so that the anti-fretting layer has a more homogenous property profile.

According to one embodiment variant of the multi-layered plain bearing the anti-fretting layer has a layer thickness of at least 50%, in particular at least 150%, and a maximum of 1,000%, preferably a maximum of 300%, of the roughness Rz of the support layer or an intermediate layer arranged between the support layer and the anti-fretting layer. In this way a “leveling effect” of the layer beneath the anti-fretting layer is achieved, wherein at the same time by means of the existing roughness an improved adhesion can be achieved between said layer and the anti-fretting layer. In particular, in this way abrasion is avoided more effectively which may be caused by profile peaks of the roughness profile of the layer underneath the anti-fretting layer.

To increase the adaptability of the multi-layered plain bearing to a surface of the housing mounting the latter it is possible for the anti-fretting layer to have a coating which is softer than the anti-fretting layer. Preferably, said coating is made of a material which is selected from a group comprising tin, lead, bismuth, polymer-based anti-frictional paints.

For a better understanding of the invention the latter is explained in more detail with reference to the following figures.

In a much simplified representation:

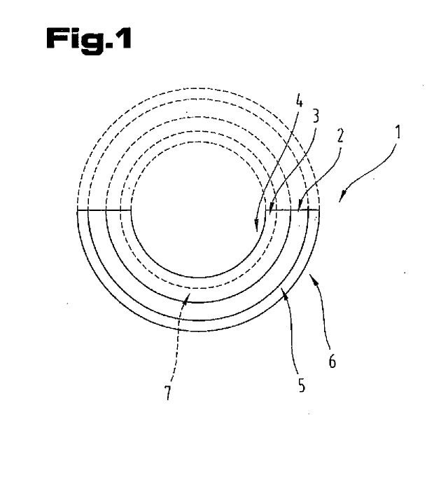

FIG. 1 shows a multi-layered plain bearing in the form of a plain bearing half shell in side view;

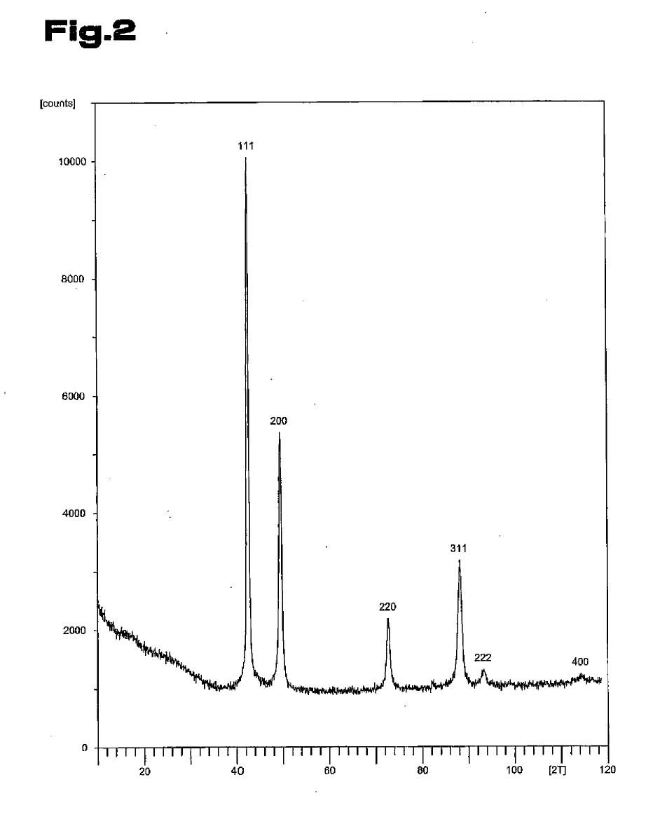

FIGS. 2 to 7 show the X-ray diffractogram of anti-fretting layers according to the invention;

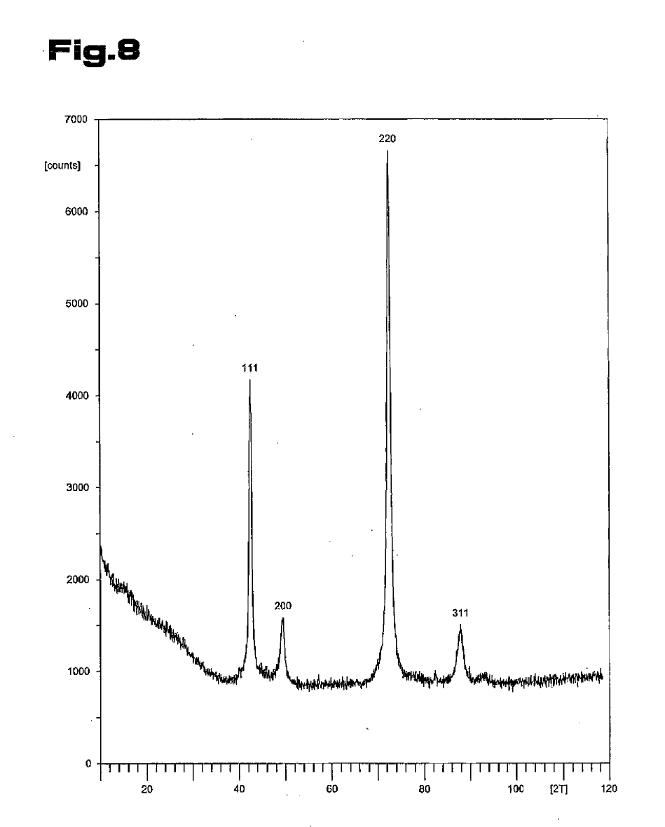

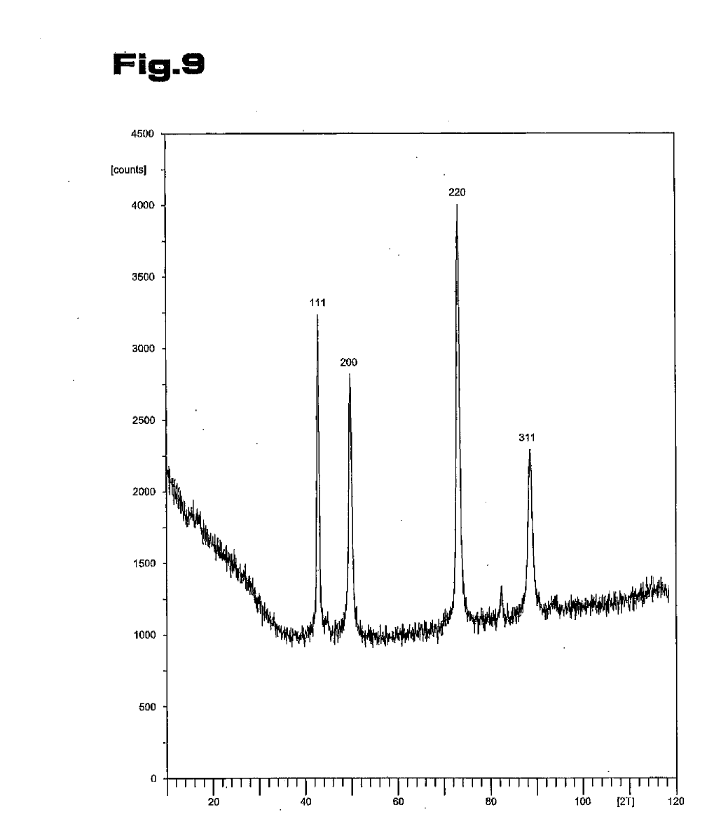

FIGS. 8 and 9 show the X-ray diffractogram of anti-fretting layers according to GB 556, 248 A;

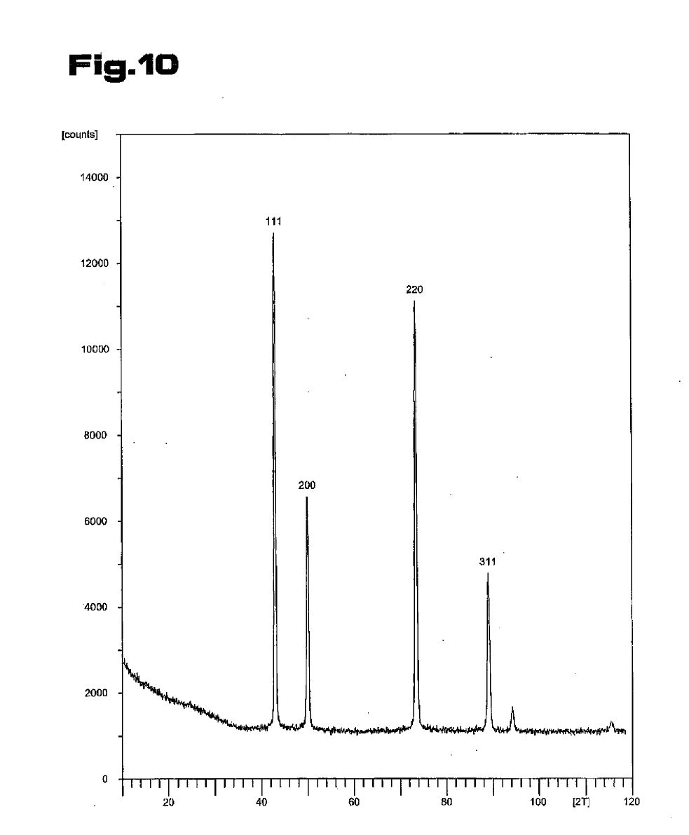

FIG. 10 shows the X-ray diffractogram of an anti-fretting layer according to WO 02/48563 A1;

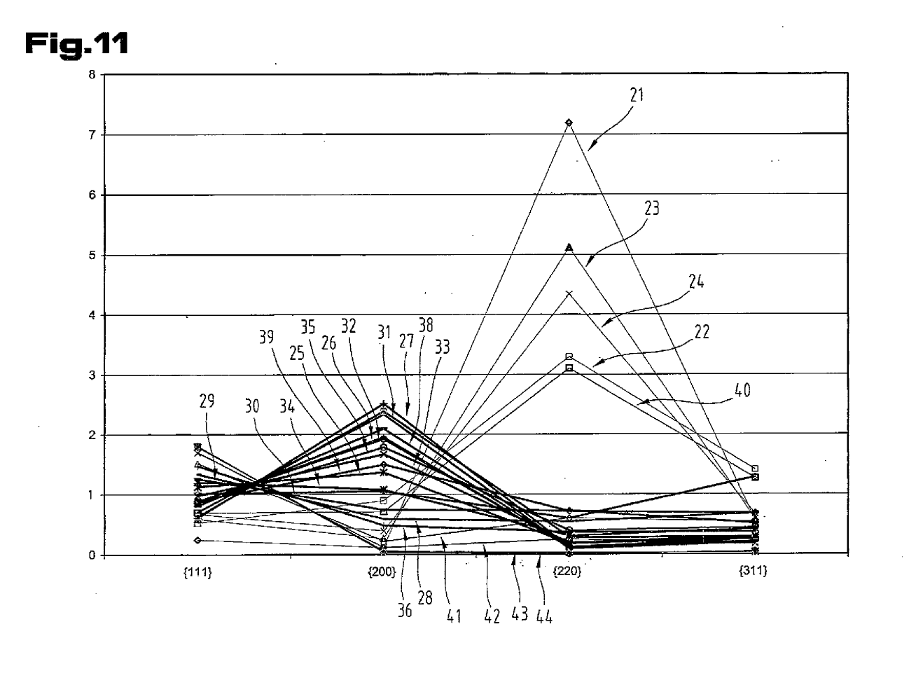

FIG. 11 shows a diagram with the orientation indices of different anti-fretting layers.

First of all, it should be noted that details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

FIG. 1 shows a multi-layered plain bearing 1 in the form of a plain bearing half shell. A three-layered variant of the multi-layered plain bearing 1 is shown, consisting of support layer 2, an anti-frictional layer 3, which is arranged on a front side 4 of the multi-layered plain bearing 2, which faces the component to be mounted, and an anti-fretting layer 5, which is arranged on a rear side 6 of the multi-layered plain bearing 1 and on the support layer 2. If necessary a bearing metal layer 7 can be arranged between the anti-frictional layer 4 and the support layer 2, as indicated by dashed lines in FIG. 1.

The main structure of such multi-layered plain bearings 1, as used e.g. in internal combustion engines, is known from the prior art and further explanations are therefore unnecessary here. It should be mentioned however that additional layers can be provided, for example an adhesive layer and/or a diffusion barrier layer can be provided between the anti-frictional layer 4 and the bearing metal layer 3 and/or between the anti-fretting layer 5 and the support layer 2, likewise an adhesive layer can be provided between the bearing metal layer 3 and the support layer 2.

Within the scope of the invention the multi-layered plain bearing 1 can also be configured differently, for example as a bearing bush, as indicated by dashed lines in FIG. 1. Also embodiments such as run-on rings, axially running sliding shoes or the like are possible.

Furthermore, it is also possible within the scope of the invention that the bearing metal layer 3 is not used, so that the anti-frictional layer 4 can be applied either directly or with the intermediate arrangement of an adhesive and/or a diffusion barrier layer on the support layer 2.

The support metal layer 2 is preferably made of steel but can also be made from a material which gives the multi-layered plain bearing 1 the necessary structural strength. Such materials are known from the prior art.

For the bearing metal layer 3 or the anti-frictional layer 4 and the intermediate layers the alloys or materials known from the relevant prior art can be used, and reference is made thereto.

According to the invention the anti-fretting layer 5 consists of a copper-based alloy, which contains at least one element from the group comprising germanium, tin, indium, zinc, nickel, cobalt, bismuth, lead, silver, antimony as well as unavoidable impurities originating from production, wherein the sum total of said alloy elements is at least 1 wt. % and a maximum of 30 wt. %, and wherein in the copper alloy there are copper mixed crystal grains formed by copper and the at least one element.

The tin content can be between 5 wt. % and 25 wt. %, preferably between 8 wt. % and 19 wt. %, in particular between 10 wt. % and 16 wt. %.

The zinc content can be between 0.5 wt. % and 25 wt. %, preferably between 1 wt. % and 5 wt. %.

The content of germanium can be between 3 wt. % and 15 wt. %, preferably between 4 wt. % and 10 wt. %.

The content of indium can be between 0.2 wt. % and 20 wt. %, preferably between 1 wt. % and 5 wt. %, in particular between 2 wt. % and 4 wt. %.

The content of nickel can be between 0.2 wt. % and 8 wt. %, preferably between 0.5 wt. % and 5 wt. %, in particular between 1 wt. % and 3 wt. %.

The content of cobalt can be between 0.2 wt. % and 8 wt. %, preferably between 0.5 wt. % and 5 wt. %, in particular between 1 wt. % and 3 wt. %.

The content of bismuth can be between 1 wt. % and 25 wt. %, preferably between 2 wt. % and 15 wt. %, in particular between 5 wt. % and 10 wt. %.

The content of lead can be between 1 wt. % and 25 wt. %, preferably between 2 wt. % and 15 wt. %, in particular between 5 wt. % and 10 wt. %.

The content of antimony can be between 0.2 wt. % and 15 wt. %, preferably between 0.2 wt. % and 10 wt. %, in particular between 1 wt. % and 5 wt. %.

The proportion of silver in the copper-based alloy can be between 1 wt. % and 20 wt. %, preferably between 2 wt. % and 10 wt. %.

Preferably, the content of one or more of the elements germanium, indium, zinc, nickel, cobalt, bismuth, lead, silver and antimony is a total of between 0.2 wt. % and 20 wt. %.

By means of zinc, indium, germanium and Sb the tendency of the copper material to weld with the steel is also reduced. The Applicant suspects that on the one hand the mutual solubility of the housing material in the coating material and vice versa reduces the transfer of material and improves the resistance to corrosion and mechanical resistance to wear and fatigue by forming a substitution mixed crystal and in that by means of the alloy partner the formation of thin adhesive oxide layers and/or reaction layers separating the surfaces from one another with oil additives is improved.

By combining said elements the properties of the coating can be adjusted specifically or tailored to the respective application.

It was observed that below a specific content the effect is too small, above a certain value and in particular above a total of 30 wt. % large amounts of hard, brittle intermetallic phases are formed which have a negative influence on the anti-fretting layer.

Thus for example a Cu—Sn or Cu—Ge alloy with the addition of 1 wt. % to 25 wt. % Zn or 1 wt. % to 20 wt. % indium is considerably less sensitive to corrosion, in particular of sulfur-containing oil additives.

A Cu—Al alloy becomes much more resistant to wear by the addition of 0.2 wt. % to 15 wt. % antimony, as a portion of the alloy elements is deposited as a finely dispersed AlSb hard phase.

By alloying with nickel and/or cobalt the mechanical strength of the coating and its resistance to corrosion can be greatly increased. In particular, the shapability can also be improved by means of nickel. Unfortunately, by means of these elements the tendency to weld with the housing material is increased. This effect was observed in particular at contents of over 5 wt. %, in particular over 10 wt. %.

By alloying one more elements from the group lead, bismuth and silver or by adding solid lubricants such as graphite, MoS₂, WS₂ a further phase is added to the structure which has particularly good anti-frictional properties. In this way fretting damage can be reduced further or damage under extreme operating conditions can be reduced (comparable with the emergency running properties of a bearing metal).

Lead, bismuth and solid lubricants are particularly soft materials, which could potentially weaken the resistance of coating to stress, therefore its content should have an upper limit.

Silver is severely affected by many, in particular sulfur-containing oil additives. This unwanted effect is particularly marked at contents of over 20 wt. %.

Said copper-based alloys are preferably deposited galvanically on the rear side 6 on the respective substrate, for example the support layer 2. The electrolyte for this can contain cyanide or can preferably be cyanide free. Preferred parameters for the deposition and preferred bath compositions are described in the following examples.

### EXAMPLE 1

### Cyanide-Containing Electrolyte

| | |
|---|---|
| copper (I) | 0.25 mol/l-0.35 mol/l |
| tin (IV) | 0.10 mol/l-0.20 mol/l |
| free cyanide | 0.30 mol/l-0.45 mol/l |
| free alkalinity | 0.20 mol/l-0.30 mol/l |
| tartrate | 0.10 mol/l-0.20 mol/l |
| additive | 0.5 g/l-5 g/l |
| temperature | 55° C.-65° C. |
| current density | 1 A/dm²-4 A/dm² |

### EXAMPLE 2

### Cyanide-Free Electrolyte Based on Methane Sulfonic Acid or Tetrafluoroboric Acid

| | |
|---|---|
| copper (II) | 0.25 mol/l-0.35 mol/l |
| tin (II) | 0.10 mol/l-0.20 mol/l |
| free acid | 0.8 mol/l-2 mol/l |
| additive | 5 g/l-50 g/l |
| temperature | 20° C.-30° C. |
| current density | 0.5 A/dm²-3 A/dm² |

### EXAMPLE 3

### Cyanide-Free Electrolyte Based on Pyrophosphate or Phosphonate

| | |
|---|---|
| copper (II) | 0.10 mol/l-0.40 mol/l |
| tin (II) | 0.05 mol/l-0.50 mol/1 |
| pH value | 8-10 |
| additive | 0.5 g/l-50 g/l |
| temperature | 40° C.-80° C. |
| current density | 0.5 A/dm²-5 A/dm² |

In the preferred embodiment of the electrolyte the latter also contains organic compounds in addition to the salts for the metals to be deposited. In particular, in the case of cyanide electrolytes the latter are polycarboxylic acid salts such as citrate or tartrate, in the case of the non-cyanide acidic electrolytes the latter are naphthol or naphthol derivatives or thio compounds. In this way the alignment of the invention can be maintained over a wide range of bath parameters.

The following salts can be used for depositing the metals:

Copper can be used in the form of copper(II)tetrafluoroborate, copper(II)methane sulfonate, copper(II)sulfate, copper(II)pyrophosphate, copper(I)cyanide, copper salts of hydroxy and/or aminophosphonic acids. In general, the concentration of copper in the electrolyte can be between 0.05 mol/l and 1 mol/l.

Tin can be used in the form of tin(II)tetrafluoroborate, tin(II)methane sulfonate, tin(II)sulfate, tin(II)pyrophosphate, sodium stannate, potassium stannate, tin(II)salts of hydroxy and/or aminophosphonic acids. In general, the concentration of tin in the electrolyte can be up to 0.5 mol/l.

Zinc can be used in the form of zinc(II)tetrafluoroborate, zinc(II)methane sulfonate, zinc(II)sulfate, zinc(II)pyrophosphate, zinc oxide, zinc cyanide, zinc(II)salts of hydroxy and/or aminophosphonic acids. In general, the concentration of zinc in the electrolyte can be up to 0.5 mol/l.

Germanium can be used in the form of germanium oxide or sodium or potassium germanate. In general, the concentration of germanium in the electrolyte can be up to 0.5 mol/l.

Indium can be used in the form of indium oxide, indium cyanide, indium sulfate, indium fluoroborate, indium methane sulfonate. In general, the concentration of indium in the electrolyte can be up to 0.5 mol/l.

Nickel can be used in the form of nickel(II)tetrafluoroborate, nickel(II)methane sulfonate, nickel(II)sulfate, ammonium-nickel-sulfate, nickel(II)chloride, nickel(II)pyrophosphate, nickel(II)oxide. In general, the concentration of nickel in the electrolyte can be up to 1 mol/l.

Cobalt can be used in the same form and concentration as nickel.

Bismuth can be used in the form of bismuth trifluoride, bismuth(III)methane sulfonate, bismuth(III)sulfate, bismuth(III)pyrophosphate, bismuth oxide, sodium or potassium bismutate. In general, the concentration of bismuth in the electrolyte can be up to 0.5 mol/l.

Lead can be used in the form of lead(II)tetrafluoroborate, lead(II)methane sulfonate, lead(II)pyrophosphate, lead acetate, lead(II)oxide, sodium or potassium plumbate. In general, the concentration of lead in the electrolyte can be up to 0.3 mol/l.

Silver can be used in the form of cyanide, alkali silver cyanide, silver methane sulfonate, silver nitrate. In general, the concentration of antimony in the electrolyte can be up to 0.5 mol/l.

Antimony can be used in the form of antimony(III)tetrafluoroborate, antimony trifluoride, antimony(III)oxide, potassium antimony tartrate. In general, the concentration of antimony in the electrolyte can be up to 0.2 mol/l.

Possible stabilizers or supporting electrolytes, conducting salts or complexing agents are: alkali cyanide, alkali hydroxide, tetrafluoroboric acid, hydrofluoric acid, methane sulfonic acid, tartaric acid and the alkali and ammonium salts thereof, citric acid and the alkali and ammonium salts thereof, ammonium and alkali pyrophosphates, phosphoric acid the alkali and ammonium salts thereof, 2.2-ethylene dithiodiethanol, hydantoin and derivatives thereof; succinimide and derivatives thereof, phenol and cresol sulfonic acids, in a total concentration of between 0.1 mol/l and 2 mol/l.

Possible oxidation inhibitors in cyanide-free electrolytes are: resorcin, hydroquinone, pyrocatechol, pyrogallol, formaldehyde, methanol, in a total concentration of between 0.03 mol/l and 0.3 mol/l.

Possible additives are: phenolphthalein, thio compounds and derivatives thereof, thiourea and the derivatives thereof, alpha or beta naphtol and their ethoxylates, alpha and beta naphthol sulfonic acid and their ethoxylates, o-toluidin, hydroxyl chinolin, lignosulfonate, butindiol, in a total concentration of between 0.0005 mol/l and 0.05 mol/l, preferably 0.002 mol/l and 0.02 mol/l and gelatin, glue, non-ionic and cationic surfactants, amino compounds, for example C8-C20-amidopropylamine and derivatives thereof, polyethylene glycol and its functional derivatives, peptone, glycine, in a total concentration of between 0 g/l-50 g/l.

Also mixtures of the aforementioned components of the electrolytes can be used, i.e. e.g. at least two salts of a or the respective metal and/or at least two stabilizers and/or at least two oxidation inhibitors and/or at least two additives.

It should be noted that for safety reasons cyanide-containing electrolytes can only be produced from alkali salts or premixtures.

The alloy elements can be added in the form of the aforementioned, soluble compounds or complexes to a corresponding electrolyte and are deposited therewith from the latter. Similarly it is possible to form an alloy by diffusing the elements into the layer or co-depositing particles suspended in the electrolyte.

The deposition of the respective anti-fretting layer 5 can be performed on an already pre-formed multi-layered plain bearing 1, e.g. on a plain bearing half shell. Similarly it is possible within the scope of the invention that the anti-fretting layer 5 is deposited on a flat substrate strip, for example a steel strip, and the mechanical shaping into a finished multi-layered plain bearing 1 is performed for example by pressing etc., only in a subsequent production step.

The anti-fretting layer can also be applied after the application of an intermediate layer or adhesive layer, for example made of copper or nickel, onto the substrate. Intermediate layers of this kind usually have a thickness of 0 μm-4 μm, preferably 0 μm-2 μm. Similarly the embodiment of the anti-fretting layer as a multiple layer with different compositions or as gradient layer is possible. In the case of a gradient layer a concentration gradient for copper can be established, whereby the concentration of copper is greatest at the boundary layer with the support layer 2 in the anti-fretting layer 5. The gradient can be linear or non-linear, it is also possible to have a continuous or a discontinuous concentration gradient.

In this way anti-fretting layers 5 with the compositions given in Table 1 were produced. Details on the composition are given in wt. %.

TABLE 1
Compositions of anti-fretting layers 5

| | Si | Ge | Sn | In | Zn | Ni | Co | Bi | Pb | Sb | Cu |
|---|---|---|---|---|---|---|---|---|---|---|---|
| 1 | 2 | | | | | 2 | | | | | Rem. |
| 2 | 5 | | | 2 | | | | | | | Rem. |
| 3 | | 4 | | | 5 | | | | | | Rem. |
| 4 | | 10 | | | | | | | | | Rem. |
| 5 | | 15 | | 1 | | 5 | | | | | Rem. |
| 6 | | | 10 | 3 | | | | | | | Rem. |
| 7 | | | 15 | 2 | | | | | | | Rem. |
| 8 | | | 20 | | 3 | | | | | | Rem. |
| 9 | | | 10 | | 5 | | 0.5 | | | | Rem. |
| 10 | | | 13 | | 1 | | | | | | Rem. |
| 11 | | | 10 | | 1 | | | | 10 | | Rem. |
| 12 | | | 10 | | | | | 15 | | | Rem. |
| 13 | | | 5 | | 5 | | | | 15 | | Rem. |
| 14 | | | 5 | | | | | | | 2 | Rem. |
| 15 | | 2 | 10 | | | | | | | | Rem. |
| 16 | | | 17 | | 2 | | | 10 | | | Rem. |
| 17 | | | 12 | | | | | | 9 | | Rem. |
| 18 | 1 | 2 | 5 | | 5 | | | | | | Rem. |
| 19 | | | 11 | 3 | | | | | | | Rem. |
| 20 | | | 24 | | | | 5 | | | | Rem. |

For comparison the following CuSn alloys were also produced and in Table 2 examples 21 to 24 show an anti-fretting layer according to GB 2315301 A1 on steel and examples 25 to 39 and 41 to 44 show anti-fretting layers 5 according to the invention on steel. In example 40 according to WO 02/48563 A1 an CuSn6 alloy was applied onto a Ti connecting rod. The Sn amounts in Table 2 are given in wt. %. Cu forms the remainder to 100 wt. %. In examples 25 to 39 according to the invention the CuSn alloys were deposited from a cyanide-containing electrolyte and those in examples 41 to 44 were deposited from a cyanide-free electrolyte.

TABLE 2
CuSn alloys

| No. | Sn |
|---|---|
| 21 | 11 |
| 22 | 8.4 |
| 23 | 15 |
| 24 | 13 |
| 25 | 12 |
| 26 | 14 |
| 27 | 17 |
| 28 | 12.5 |
| 29 | 9 |
| 30 | 10 |
| 31 | 13 |
| 32 | 15 |
| 33 | 10.8 |
| 34 | 16 |
| 35 | 10 |
| 36 | 18 |
| 37 | 15 |
| 38 | 16 |
| 39 | 9 |
| 40 | 6 |
| 41 | 10 |
| 42 | 12 |
| 43 | 14 |
| 44 | 16 |

It was shown in the test that the CuSn alloys according to the invention had much better properties than the CuSn alloys according to the prior art. Here a cylindrical stamp (showing the housing bore) was pressed with a pressure of 10 MPa onto a plate coated with corresponding materials (showing the bearing rear). The contact area was oiled. The stamp and plate were exposed to a relative movement of 0.1 mm amplitude at a frequency of 10 Hz. All of the trials were carried out at 120° C. over 1,000,000 relative movements. After the completion of the trial the contact points on the plate and stamp were examined. In all of the samples oil carbons formed on the contact surfaces. The level of damage was graded between 1—no damage and 10—heavy fretting. The results are summarized in Table 3.

TABLE 3
Test results for examples 21 to 44

| No. | |
|---|---|
| 21 | 10 |
| 22 | 8 |
| 23 | 9 |
| 24 | 7 |
| 25 | 3 |
| 26 | 2 |
| 27 | 5 |
| 28 | 5 |
| 29 | 2 |
| 30 | 2 |
| 31 | 4 |
| 32 | 3 |
| 33 | 3 |
| 34 | 2 |
| 35 | 4 |
| 36 | 3 |
| 37 | 2 |
| 38 | 3 |
| 39 | 3 |
| 40 | 6 |
| 41 | 3 |
| 42 | 3 |
| 43 | 4 |
| 44 | 4 |

The trials were performed with different stamp materials (e.g. steel cast iron, aluminum, titanium) and surface conditions (ground, shot-peened, etc.) and also with panels without a coating and with different surface conditions, whereby the above results were confirmed. In addition, the trial parameters such as pressing, amplitude, temperature and lubricating oil were varied. The results were correlated with the results from engine trials and test results on parts from the field. With the anti-fretting layers 5 of the invention compared to the layers of the prior art a further, clear reduction in the fretting damage from fretting can be achieved.

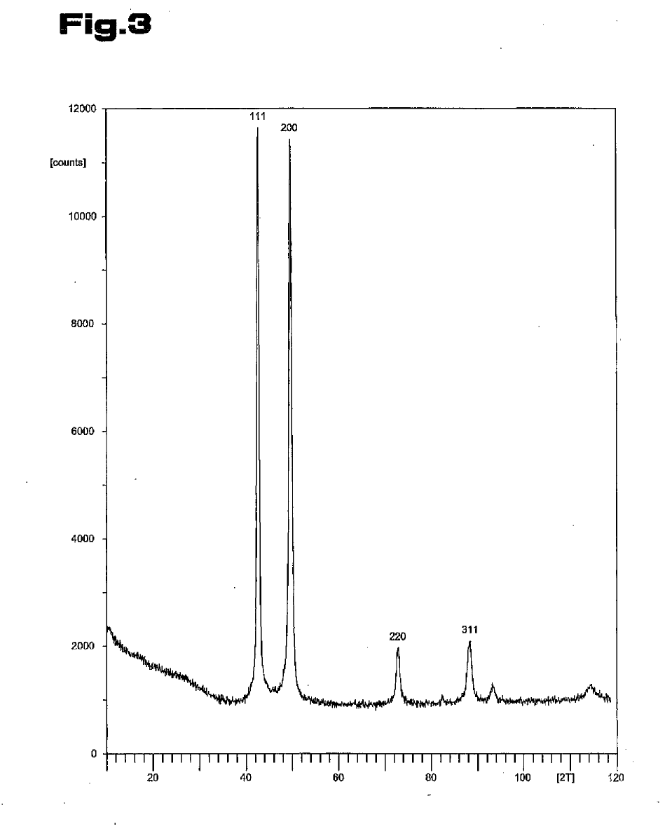

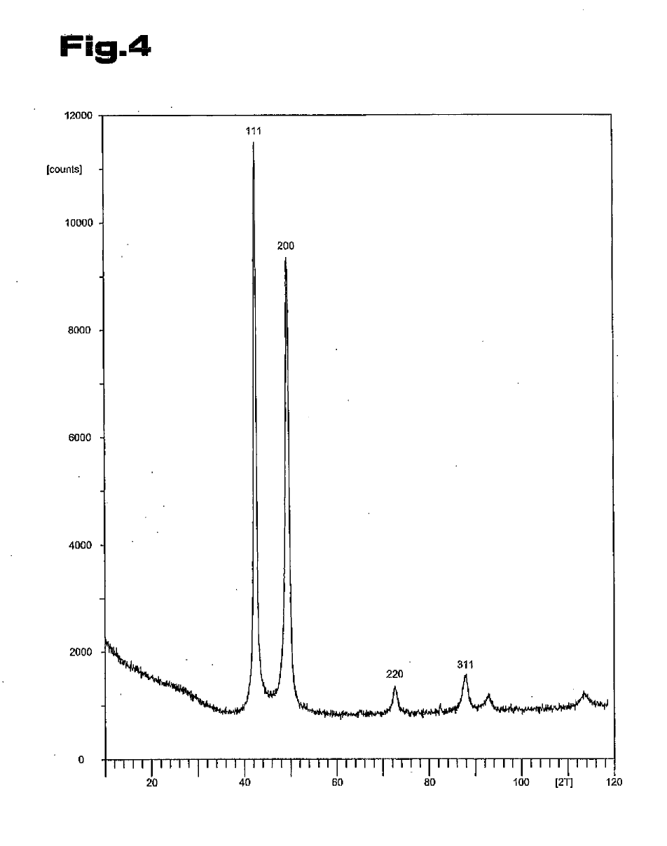

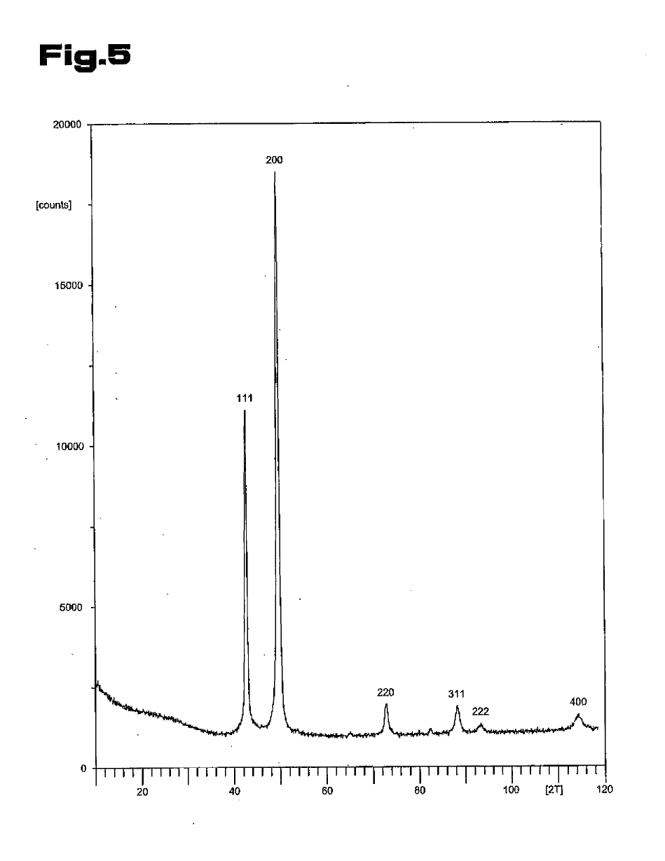

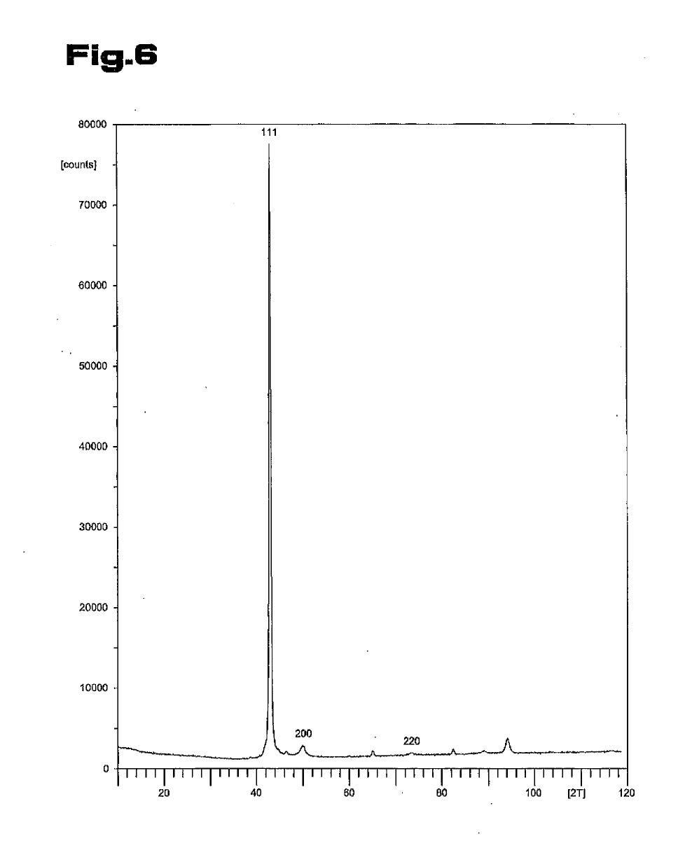

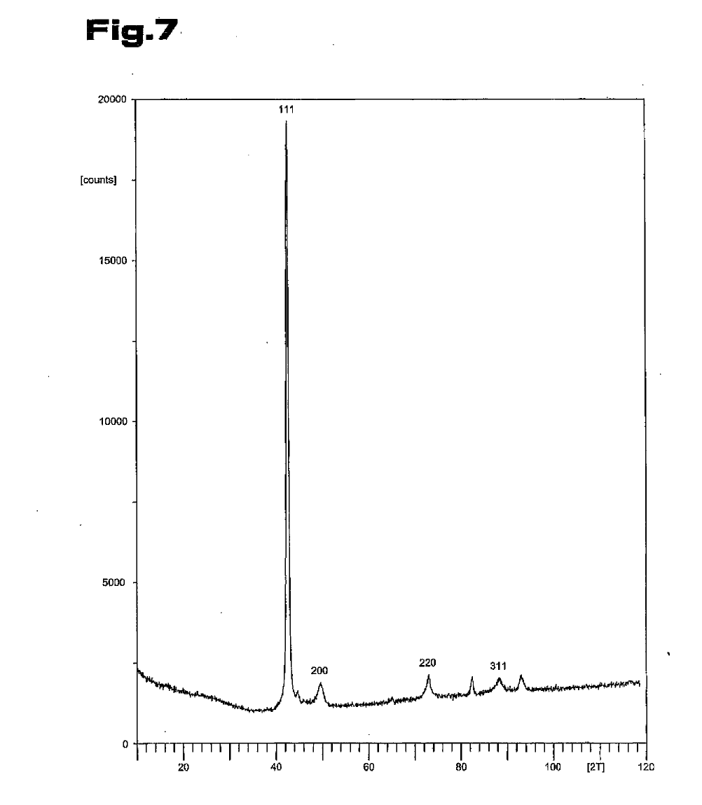

In order to verify these differences the X-ray structure of the anti-fretting layers 5 was examined. FIGS. 2 to 10 show the X-ray diffractograms of examples 30 (FIG. 2), 35 (FIG. 3), 33 (FIG. 4), 31 (FIG. 5), 43 (FIG. 6), 42 (FIG. 7), 23 (FIG. 8), 22 (FIG. 9), 40 (FIG. 10). The results of the X-ray diffractograms of the other examples are not shown, as they do contribute anything to the understanding of the invention further than the findings obtained from FIGS. 2 to 10.

Although said X-ray diffractograms are revealing in themselves in a direct comparison, for a better comparison of the relative intensities of the diffraction patterns of the CuSn alloys according to examples 21 to 44 the orientation index of the copper mixed crystal grains was calculated. The result is shown graphically in FIG. 11 and numerically in Table 3 and Table 4 also gives the values of a completely unoriented Cu powder sample.

The orientation indices are calculated according to the formula

$$M \{ hkl \} = \frac{I \{ hkl \} \sum {I}^{0} \{ hkl \}}{{I}^{0} \{ hkl \} \sum I \{ hkl \}}$$

wherein I{hkl} represents the X-ray diffraction intensities for the {hkl} lattice planes of the anti-fretting layer and I⁰{hkl} represents the X-ray diffraction intensities of the completely unoriented copper powder sample.

TABLE 4
Orientation indices

| | Relative intensity I {hkl} | | | | | Orientation index M {hkl} | | | |
|---|---|---|---|---|---|---|---|---|---|
| Example | {111} | {200} | {220} | {311} | Sum. | {111} | {200} | {220} | {311} |
| Cu powder (00- | 100 | 46 | 20 | 17 | 183.0 | 1 | 1 | 1 | 1 |
| 004-0836) | | | | | | | | | |
| 21 | 17.1 | 3.7 | 100 | 6.5 | 127.3 | 0.25 | 0.12 | 7.19 | 0.6 |
| 22 | 79.4 | 62.3 | 100 | 36.4 | 278.1 | 0.5 | 0.9 | 3.3 | 1.4 |
| 23 | 57.3 | 11.9 | 100 | 9.5 | 178.7 | 0.6 | 0.3 | 5.1 | 0.6 |
| 24 | 77.4 | 20.6 | 100 | 13 | 211.0 | 0.7 | 0.4 | 4.3 | 0.7 |
| 25 | 100 | 56 | 3.1 | 4 | 163.1 | 1.1 | 1.4 | 0.2 | 0.3 |
| 26 | 99.1 | 100 | 2.5 | 5.1 | 206.7 | 0.9 | 1.9 | 0.1 | 0.3 |
| 27 | 52.4 | 100 | 2 | 3.8 | 158.2 | 0.6 | 2.5 | 0.1 | 0.3 |
| 28 | 65.5 | 100 | 1.7 | 3.1 | 170.3 | 0.7 | 2.3 | 0.1 | 0.2 |
| 29 | 100 | 27 | 11.5 | 6.9 | 145.4 | 1.3 | 0.7 | 0.7 | 0.5 |
| 30 | 100 | 47.8 | 11.8 | 21.6 | 181.2 | 1.0 | 1.1 | 0.6 | 1.3 |
| 31 | 57.2 | 100 | 5.2 | 4.4 | 166.8 | 0.6 | 2.4 | 0.3 | 0.3 |
| 32 | 97.9 | 100 | 2.5 | 3.6 | 204.0 | 0.9 | 2.0 | 0.1 | 0.2 |
| 33 | 100.0 | 78.9 | 3.9 | 5.2 | 188.0 | 1.0 | 1.7 | 0.2 | 0.3 |
| 34 | 100.0 | 41.1 | 5.1 | 5.9 | 152.1 | 1.2 | 1.1 | 0.3 | 0.4 |
| 35 | 100.0 | 96.1 | 9.2 | 8.8 | 214.1 | 0.9 | 1.8 | 0.4 | 0.4 |
| 36 | 100.0 | 14.9 | 5.0 | 4.3 | 124.2 | 1.5 | 0.5 | 0.4 | 0.4 |
| 37 | 100.0 | 20.3 | 8.1 | 8.7 | 137.1 | 1.3 | 0.6 | 0.5 | 0.7 |
| 38 | 83.5 | 100.0 | 2.4 | 3.8 | 189.7 | 0.8 | 2.1 | 0.1 | 0.2 |
| 39 | 100.0 | 77.9 | 16.1 | 13.0 | 207.0 | 0.9 | 1.5 | 0.7 | 0.7 |
| 40 | 100.0 | 46.8 | 92.6 | 30.9 | 270.3 | 0.7 | 0.7 | 3.1 | 1.3 |
| 41 | 100.0 | 6.7 | 7.9 | 6.0 | 120.6 | 1.5 | 0.2 | 0.6 | 0.5 |
| 42 | 100.0 | 3.1 | 3.0 | 1.7 | 107.8 | 1.7 | 0.1 | 0.3 | 0.2 |
| 43 | 100 | 1.5 | 0.3 | 0.3 | 102.1 | 1.8 | 0.1 | 0.1 | 0.1 |
| 44 | 100 | 1 | 0.1 | 0.4 | 101.5 | 1.8 | 0.1 | 0.0 | 0.1 |

FIG. 11 shows the respective orientation index for the individual lattice plane sets from Table 4 on the y-axis and the associated lattice plane sets on the x-axis. As shown in FIG. 11, the samples according to the prior art corresponds to paths 21 to 24 and 40 a clear manifestation of the orientation index M {220}. In contrast M {220} in the samples according to the invention compared to M {200} is clearly in the background. According to the invention each of the lattice plane sets {hkl} has a value of less than 2.75, in particular exceeds the orientation index of the {220} reflex. Preferably, the X-ray diffraction intensity of the {200} lattice planes is between 50% and 200% of the X-ray diffraction intensity of the {111 } lattice planes, or the sum of the X-ray diffraction intensity of I{111} and I{200} is at least 70%, preferably at least 80%, of the total X-ray diffraction intensity.

It is also shown in FIG. 11 that in the case of CuSn alloys deposited from cyanide-free electrolytes the orientation index M {200} is much lower than with CuSn alloys deposited from cyanide-containing electrolytes, whereas the orientation index M {111} has a greater value. Said cyanide-free electrolytes all have at least one organic compound according to the aforementioned details. In a preferred embodiment of the anti-fretting layer 5 therefore the X-ray diffraction intensity I{111} is at least 70%, preferably at least 85%, of the total X-ray diffraction intensity.

Similar results are shown with copper-based alloys with the aforementioned alloy elements or at least one of the aforementioned alloy elements Si, Ge, In, Zn, Ni, Co, Bi, Pb and Sb, and these results are not reproduced here so as not to exceed the scope of the description.

According to a preferred embodiment variant of the anti-fretting layer 5 the latter has a layer thickness of between 2 μm and 100 μm, preferably between 3 μm and 30 μm, in particular between 4 μm and 15 μm, as already explained above.

As already explained above, the anti-fretting layer 5 has a layer thickness of at least 50%, in particular at least 150%, and a maximum of 1,000%, preferably a maximum of 300%, of the roughness Rz of the support layer or an intermediate layer arranged possibly between the support layer and the anti-fretting layer.

In particular, the anti-fretting layer 5 for the aforementioned reasons has a Vickers micro-hardness at a test load of 3 Pond of between HV 200 and HV 500, preferably between HV 230 and HV 400, in particular between HV 250 and HV 350.

Evaluations of micrographs have shown that there is an improvement in the properties of the anti-fretting layer 5, if the copper mixed crystal grains have a grain size of more than 5 nm, preferably more than 10 nm, in particular more than 50 nm.

XRD measurements of the anti-fretting layer 5 have also shown that copper-based alloys have better properties, if the latter are essentially free of intermetallic phases and appear as a mixed crystal with copper crystal lattice, whereby it is particularly preferable if said copper-based alloys are made of copper mixed crystals with a lattice constant of between 0.3630 nm and 0.3750 nm.

For the aforementioned reasons the anti-fretting layer 5 can also have a coating which is softer than the anti-fretting layer 5, wherein the coating is preferably made from a material which is selected from a group comprising tin, lead, silver, bismuth, polymer-based antifrictional paints. In principle, all antifrictional paints can be used that are known in the field of plain bearings. Preferably however an antifrictional paint is used which in a dry state consists of 40 wt. % to 45 wt. % MoS2, 20 wt. % to 25 wt. % graphite and 30 wt. % to 40 wt. % polyamide imide, whereby if necessary hard particles such as e.g. oxides, nitrides or carbides, can be included in the antifrictional paint in a proportion of a total of a maximum 20 wt. %, which replace a proportion of the solid lubricants.

As a point of formality it should be noted that for a better understanding of the structure of the multi-layered plain bearing 1 the latter or its components have not been represented true to scale in part and/or have been enlarged and/or reduced in size.

### LIST OF REFERENCE NUMERALS

1 multi-layered plain bearing
2 support layer
3 anti-frictional layer
4 front side
5 anti-fretting layer
6 rear side
7 bearing metal layer
21 path
22 path
23 path
24 path
25 path
26 path
27 path
28 path
29 path
30 path
31 path
32 path
33 path
34 path
35 path
36 path
37 path
38 path
39 path
40 path
41 path
42 path
43 path
44 path

1. An anti-fretting layer (5) for a multi-layered plain bearing (1) consisting of a copper-based alloy, which in addition to copper as the main alloy element contains at least one from the group germanium, tin, indium, zinc, nickel, cobalt, bismuth, lead, silver, antimony as well as unavoidable impurities originating from production, the total proportion of these alloy elements being at least 1 wt. % and a maximum of 30 wt. %, and in the copper alloy there are copper mixed crystal grains formed from copper and the at least one element, wherein the copper mixed crystal grains are oriented in such a way that an orientation index M{hkl} according to the formula
$$M \{ hkl \} = \frac{I \{ hkl \} \sum {I}^{0} \{ hkl \}}{{I}^{0} \{ hkl \} \sum I \{ hkl \}}$$
of each of the lattice plane sets {hkl} has a value of less than 3.0, wherein I{hkl} represents the X-ray diffraction intensities for the {hkl} lattice planes of the anti-fretting layer and I0{hkl} represents the X-ray diffraction intensities of the completely unoriented copper powder sample.

2. The anti-fretting layer (5) as claimed in claim 1, wherein the orientation index of the {220} reflex falls below the value 1.0.

3. The anti-fretting layer (5) as claimed in claim 1, wherein the X-ray diffraction intensity of the {200} lattice planes is between 50% and 200% of the X-ray diffraction intensity of the {111} lattice planes.

4. The anti-fretting layer (5) as claimed in claim 1, wherein the sum of the X-ray diffraction intensity of I{111} and I{200} is at least 70%, preferably at least 80%, of the total X-ray diffraction intensity.

5. The anti-fretting layer (5) as claimed in claim 1, wherein the X-ray diffraction intensity I{111} is at least 70%, preferably at least 85%, of the total X-ray diffraction intensity.

6. The anti-fretting layer (5) as claimed in claim 1, wherein the tin content is between 5 wt. % and 25 wt. %, preferably between 8 wt. % and 19 wt. %, in particular between 10 wt. % and 16 wt. %.

7. The anti-fretting layer (5) as claimed in claim 1, wherein the zinc content is between 0.5 wt. % and 25 wt. %, preferably between 1 wt. % and 5 wt .%.

8. The anti-fretting layer (5) as claimed in claim 1, wherein the content of one or more of the elements germanium, indium, zinc, nickel, cobalt, bismuth, lead, silver and antimony in total is between 0.2 wt. % and 20 wt. %.

9. The anti-fretting layer (5) as claimed in claim 1, wherein the latter has a layer thickness of between 2 μm and 100 μm, preferably between 3 μm and 30 μm, in particular between 4 μm and 15 μm.

10. The anti-fretting layer (5) as claimed in claim 1, wherein the latter has a Vickers microhardness in a test load of 3 Pond of between HV 200 and HV 500, preferably between HV 230 and HV 400, in particular between HV 250 and HV 350.

11. The anti-fretting layer (5) as claimed in claim 1, wherein the copper mixed crystal grains have a grain size of more than 5 nm, preferably more than 10 nm, in particular more than 50 nm.

12. The anti-fretting layer (5) as claimed in claim 1, wherein the latter is essentially free of intermetallic phases and appears in the XRD measurement as a mixed crystal with a copper crystal lattice.

13. The anti-fretting layer (5) as claimed in claim 12, wherein the latter consists of copper mixed crystals with a lattice constant of between 0.3630 nm and 0.3750 nm.

14. A multi-layered plain bearing (1) comprising a front side (4) facing towards the element to be supported and a rear side (6) opposite the latter, comprising a support layer (2), an anti-frictional layer (3) arranged on the front side (4) and an anti-fretting layer (5) arranged on the rear side (6), wherein the anti-fretting layer (5) is formed according to claim

15. The multi-layered plain bearing (1) as claimed in claim 14, wherein the anti-fretting layer (5) has a layer thickness of at least 50%, preferably at least 50%, in particular at least 150%, and a maximum of 1,000%, preferably a maximum of 300%, of the roughness Rz of the support layer (5) or an intermediate layer arranged if necessary between the support layer (2) and the anti-fretting layer (5).

16. The multi-layered plain bearing (1) as claimed in claim 14, wherein the anti-fretting layer (5) has a coating which is softer than the anti-fretting layer (5).

17. The multi-layered plain bearing (1) as claimed in claim 16, wherein the coating is made of a material which is selected from a group comprising tin, lead, bismuth, silver, polymer-based antifrictional paints.

18. A method for the galvanic deposition of an anti-fretting layer (5) on the back of a support layer of a multi-layered plain bearing (1), the anti-fretting layer (5) being made from a copper alloy, which in addition to copper as the main alloy element contains at least one element from the group germanium, tin, indium, zinc, nickel, cobalt, bismuth, lead, silver, antimony as well as unavoidable impurities originating from production, the sum total of said alloy elements being at least 1 wt. % and a maximum of 30 wt. % and used in the form of salts in the electrolyte, the deposition of the anti-fretting layer (5) being performed at a temperature of below 85° C. and at a maximum current density of 6 A/dm², wherein the electrolyte contains in addition to the salts for the metals to be deposited organic compounds selected from a group comprising polycarboxylic acid salts, naphthol, naphthol derivatives, thio compounds.
